(19) United States
(12) Patent Application Publication
(10) Pub. No.: US 2026/0320449 A1
(43) Pub. Date: Oct. 15, 2026

(54) SYSTEM AND METHOD FOR ANALYZING CONTENT USING ARTIFICIAL INTELLIGENCE

(71) Applicant: XOvation Solutions, LLC, Oakton, VA (US)

(72) Inventors: Mahasti Pourdastan, Oakton, VA (US); David Richard Lease, Oakton, VA (US)

(73) Assignee: XOvation Solutions, LLC, Oakton, VA (US)

(21) Appl. No.: 19/639,436

(22) Filed: Apr. 6, 2026

Related U.S. Application Data
(60) Provisional application No. 63/788,463, filed on Apr. 14, 2025.

(51) Int. Cl. G06N 5/043

(52) U.S. Cl. CPC G06N 5/043

(57) ABSTRACT

A system and method for analyzing multimedia content using an agent-orchestrated artificial intelligence architecture is disclosed. The system receives video, audio, image, and text inputs from a user device and performs preliminary feature extraction. A server-based metadata extraction engine processes the input by qualifying modality types, extracting features using machine-learning and language-model techniques, and initiating an agent-based research process. Multiple research agents are dynamically generated to execute subtasks in parallel, each producing intermediate results. An orchestration module performs recursive correlation across the agents by comparing intermediate outputs, detecting inconsistencies, and directing refinement cycles until convergence criteria are met. The system compiles the refined results into structured metadata representing an integrated interpretation of the multimodal input.

### CROSS REFERENCE TO RELATED APPLICATION

This application claims the benefit of priority of U.S. provisional application No. 63/788,463, filed Apr. 14, 2025, the contents of which are herein incorporated by reference.

### BACKGROUND OF THE SUBJECT DISCLOSURE

The subject disclosure relates to the field of artificial intelligence and multimedia content analysis. More specifically, the subject disclosure pertains to systems and methods for capturing, analyzing, and processing, multimedia and still image contents in real-time or near-real-time using agent-based advanced artificial intelligence techniques, including Large Language Models (LLMs) and machine learning (ML) models, to extract features, identify content, and provide users with actionable metadata and supplementary information about visual media such as television programs, movies, streaming services, still images, and live events.

In today's digital age, the rapid growth of streaming media, television broadcasts, and cinematic presentations has increased the demand for technologies that can quickly interpret and provide supplementary information about multimedia content being consumed. The digital ecosystem has evolved to include diverse and multifaceted content streams that challenge conventional data processing methods, necessitating solutions that work efficiently across various types of media. As consumption patterns shift toward on-demand and interactive experiences, the need for intelligent systems that can integrate analysis of visual, audio, and textual elements in real time has become increasingly clear.

Many efforts in the digital media space have aimed to enhance the user experience by enabling immediate access to additional information regarding the content being viewed. The applicative goals in this area center on enriching user engagement by providing relevant data quickly, thereby supporting seamless interaction with media content. However, traditional approaches often involve methods that process different forms of media in isolation, thereby creating inefficiencies in delivering integrated, actionable insights during content consumption.

Despite advancements in digital content processing, challenges remain in achieving the necessary speed and accuracy for real-time analysis. Current methodologies sometimes struggle to keep pace with the dynamic nature of live and streaming media, where visual, audio, and text elements change rapidly. These existing methods may fail to capture the full complexity of modern multimedia formats, leading to delays or inaccuracies that hinder the overall user experience.

Furthermore, there is a specific challenge related to the seamless integration of analysis across different media components. Many techniques currently in operation treat individual content elements separately, resulting in fragmented data retrieval that can interrupt the continuous flow of the viewing experience. This compartmentalized approach can force users to engage in additional steps to access comprehensive information, thereby reducing the overall efficiency and intuitiveness of content interaction.

The subject disclosure performs dynamic task decomposition and orchestration to concurrently integrate analysis of audio, video, text, and still images using an agent-based artificial intelligence framework, wherein the dynamic task decomposition and orchestration comprises: inferring one or more topics of interest based on the extracted features and the user-specific settings/preferences, decomposing a user request into a plurality of subtasks based on the inferred topics of interest, and dynamically generating, for each subtask, a research agent configured with a subtask-specific objective.

As examples, if the input contains video, Orchestration dynamically generates a Vision Agent and an Audio Agent. If the audio contains speech, Orchestration dynamically generates a Speech-to-Text Agent. If the text contains ambiguous references (“that object”, “this sound”), Orchestration dynamically generates Cross-Modal Alignment Agents. Orchestration is not static; it dynamically reacts to the input/content.

The subject disclosure also performs parallel and recursive agent execution of the plurality of research agents in parallel, each research agent configured to: perform subtask-specific analysis using one or more tools or external resources, generate intermediate results and transmit the intermediate results to an Orchestration module, and evaluate its own progress using at least one evaluation criterion comprising a confidence metric, a completeness metric, or an uncertainty metric.

The subject disclosure also performs recursive correlation and refinement wherein the Orchestration module may be further adapted to compare intermediate results across the plurality of research agents. detect inconsistencies, omissions, or cross-modal conflicts among the intermediate results, initiate one or more refinement cycles by directing at least one research agent to re-analyze data, expand its search, or generate a sub-agent to resolve the detected inconsistency, and repeat the refinement cycles until the evaluation criteria satisfy a convergence condition indicating that the subtasks are complete.

The subject disclosure also compiles the completed subtask results into a unified response for delivery to the user device.

Therefore, there exists a need in the art for a system and method that can concurrently process visual, audio, still images, and textual data streams to provide cohesive, accurate, and timely information about multimedia content. Such a system should leverage advanced artificial intelligence techniques to bridge the gap between rapid content delivery and comprehensive information accessibility, thereby enriching user engagement with multimedia content.

### SUMMARY OF THE SUBJECT DISCLOSURE

The subject disclosure addresses the deficiencies in the prior art by providing a novel system and method for analyzing multimedia content using agent-based artificial intelligence. The subject disclosure introduces a comprehensive Metadata EXtraction (MEX) Engine that integrates the concurrent analysis of visual, audio, still image, and textual data streams to deliver accurate, timely, and actionable information to users.

In one aspect, the subject disclosure provides a system that includes a user device configured to capture multimedia content including video, audio, and text inputs, still images, and a server-based MEX Engine in communication with the user device. The MEX Engine may be configured to receive the multimedia content via the user device, perform edge processing to extract key input, analyze the key inputs using a combination of Large Language Models (LLMs) and machine learning models to extract features, orchestrate research using agent-based artificial intelligence to identify and retrieve metadata related to the extracted features, and transmit compiled and formatted outputs back to the user device for display.

In another aspect, the subject disclosure provides a method including the following the steps of: capturing one or more multimedia content items via a user device; performing edge processing, wherein the edge processing includes, but is not limited to, evaluating frame quality, cropping relevant windows, detecting scene changes, detecting objects, and selecting key input; transmitting the key input to the MEX Engine; analyzing the key input using one or more artificial intelligence models to determine search items; matching the determined search items with a plurality of information data sources to retrieve one or more metadata items; and outputting the one or more metadata items to the user device.

The system employs modular, agent-based architecture that may be extensible, domain-adaptable, and optimized for applications in mobile devices, augmented reality/virtual reality (AR/VR) headsets, other smart devices, and multimedia discovery interfaces. The MEX Engine combines user context, live and still image feature extraction, distributed research, and memory synthesis to provide actionable, structured metadata in response to user queries.

Advantageously, the subject disclosure provides a seamless and efficient user experience by processing multiple data streams concurrently, thereby eliminating the fragmentation and delays associated with traditional systems. The subject disclosure may be an orchestrated, agentic, multimodal reasoning engine. The use of advanced AI techniques, including LLMs for feature analysis and agentic AI for orchestration and research, enables the system to deliver comprehensive and accurate information in real-time or near-real-time.

In one aspect of the present subject disclosure, a system for analyzing multimedia content using artificial intelligence includes a user device adapted to: capture multimedia content having video, audio, and text inputs and still images from an environment; and a server-based metadata extraction engine in communication with the user device and adapted to receive the captured input via the user device. The server-based metadata extraction engine may also adapted to perform edge processing on the captured multimedia content, wherein the edge processing includes: evaluating quality of the inputs; cropping relevant windows from the video and/or still image inputs; detecting scene changes in the video inputs; detecting objects within frames of the video inputs; and selecting key frames from the video inputs; perform input qualification on the key input to validate useability and relevance; extract features from the key input using dynamic task decomposition: dynamically generating Vision Agents and Audio Agents for input containing video or still images, Speech-to-Text Agents for input containing speech, and Cross-Modal Alignment Agents if text contains ambiguous references (“that object”, “this sound”), analyzing the key inputs using one or more Large Language Models to describe scenes and features; and detecting objects and people using machine learning models; orchestrate research using agent-based artificial intelligence, wherein the orchestration provides: inferring topics of interest based on the extracted features; dynamically generating research agents to query data sources including search engines, application programming interfaces, and databases; and determining when sufficient data has been collected; compile research outputs into human-readable metadata; and transmit the compiled metadata to the user device for display.

In one embodiment of the subject disclosure, A computer-implemented method for extracting metadata from multimedia content in includes the following: receiving, at one or more processors of a metadata extraction engine, multimedia input having at least one of video data, audio data, still image data, or textual data captured via one or more hardware sensors of a user device; performing, by one or more processors, edge processing on the multimedia input to generate key input, wherein the edge processing provides at least two of: evaluating a quality score for frames or audio segments and discarding those falling below a fidelity threshold; applying a cropping algorithm to isolate a region of interest within remaining frames; detecting scene transitions; executing an object detection model to identify objects within frames; and selecting representative key frames based on object detection confidence scores; extracting, by the metadata extraction engine executing on the one or more processors, features from the key input using a hybrid feature-extraction process having concurrently executing (i) a large language model (LLM) analysis that generates a natural-language scene description and (ii) a machine-learning-based object detection process that generates bounding-box detections and semantic labels, on a common set of key input; decomposing, by an orchestration module of the metadata extraction engine, a user request into a plurality of subtasks based on the extracted features and user-specific settings stored in a memory device; dynamically instantiating, by the orchestration module, a plurality of research agents in memory of a computing system, wherein each research agent may be assigned a subtask-specific objective corresponding to one of the plurality of subtasks; executing the plurality of research agents in parallel on the one or more processors, wherein each research agent queries at least one external data source including a search engine, an application programming interface, or a database, to retrieve data relevant to its subtask-specific objective; compiling, by the metadata extraction engine, outputs from the plurality of research agents into structured metadata stored in memory; and transmitting the structured metadata from the metadata extraction engine to the user device via a network interface for display on an output device of the user device, wherein performing the edge processing further includes executing a fidelity qualification process that applies a trained machine learning model to each frame and audio segment of the multimedia input to compute a numeric quality score, and storing in a buffer only those frames and audio segments having a quality score at or above a predefined fidelity threshold; applying, to the buffered frames, a region-of-interest cropping algorithm that computes bounding coordinates based on detected scene content to remove background areas, thereby reducing the pixel data transmitted to the metadata extraction engine; detecting scene changes in the buffered frames by identifying frame-to-frame pixel variance exceeding a scene-change threshold, and segmenting the buffered frames into discrete content segments at detected scene-change boundaries; and selecting, from each content segment, one or more key frames having the highest object detection confidence scores as the key input for transmission to the metadata extraction engine, thereby reducing the volume of data processed server-side, wherein extracting features from the key input further includes: executing a first feature-extraction process providing applying a large language model to the key input to generate a natural-language scene description that identifies objects, people, actions, and contextual relationships present in the key input; concurrently executing a second feature-extraction process having one or more computer-vision machine-learning models, including at least one of a YOLO-class object detection model or a bootstrapped language-image pretraining (BLIP) model, that generate bounding-box detections and associated semantic labels for objects, people, and places within the key input; applying, for at least one vertical domain specified in the user settings, one or more domain-specific integrated feature-extraction modules to generate domain-specific feature data supplementing the semantic labels produced by the second feature-extraction process; and executing a cross-validation process, implemented via a second large language model call, that receives as input both the natural-language scene description and the bounding-box detections and domain-specific feature data, computes a semantic consistency score between the two sets of outputs, identifies and resolves conflicts using contextual reasoning, and stores a single reconciled feature data set, with low-confidence features flagged in a machine-readable structured record, in memory for use by the orchestration module, wherein dynamically instantiating the plurality of research agents includes: determining, by the orchestration module for each subtask, a modality type by classifying the subtask as pertaining to visual data, audio data, textual data, or a cross-modal combination thereof; instantiating a Vision Agent in memory and configuring the Vision Agent to execute at least one of object detection, scene segmentation, facial expression analysis, motion tracking, or optical character recognition on visual data, when the subtask modality type is visual; instantiating an Audio Agent in memory and configuring the Audio Agent to perform at least one of speech recognition, speaker identification, emotion and tone detection, environmental sound classification, or music analysis on audio data, when the subtask modality type is audio; instantiating a Text Agent in memory and configuring the Text Agent to perform at least one of intent extraction, entity linking, temporal reasoning, or narrative reconstruction on textual data, when the subtask modality type is textual; and instantiating a Cross-Modal Fusion Agent in memory and configuring the Cross-Modal Fusion Agent to correlate visual events with audio timestamps, speech references with visual objects in co-occurring frames, and emotional tone with facial expression data, to produce a unified cross-modal representation, when the subtask modality type is a cross-modal combination; further including: evaluating, by each research agent executing on the one or more processors, an intermediate result generated by that research agent against at least one evaluation criterion including: (i) a confidence score computed as a function of cross-source agreement between results returned by at least two distinct tool invocations; (ii) a completeness metric computed as the ratio of subtask-objective information fields populated to the total number of such fields; or (iii) an uncertainty metric derived from variance across multiple language model sampling runs or tool call outputs; upon determining, by comparing each evaluation criterion to a predefined threshold stored in memory, that a sufficiency condition is not satisfied, dynamically generating in memory at least one independent sub-agent having a narrower subtask objective algorithmically derived from the research agent's subtask objective by identifying the specific information fields that caused the sufficiency condition to fail; and iteratively refining, by the research agent, the intermediate result based on output received from the sub-agent, by applying a search query expansion procedure that performs at least one of keyword extraction, topic-drift detection, or relevance scoring on the prior intermediate result to formulate a refined query differing from all prior queries issued by the research agent or its sub-agents, until the sufficiency condition is satisfied or a maximum iteration count stored in memory is reached, wherein dynamically generating the sub-agent further includes allocating, by the orchestration module at the time of sub-agent instantiation, a computational budget for the sub-agent stored in memory, wherein the computational budget includes at least one of: (i) a token limit specifying a maximum number of language model inference tokens the sub-agent may consume; (ii) an execution time limit specifying a wall-clock deadline after which the sub-agent is automatically terminated; or (iii) a tool-usage limit specifying a maximum number of aggregated tool invocations across language model queries, web searches, API calls, and database lookups; encoding the computational budget into the sub-agent's runtime configuration at instantiation such that the sub-agent's execution environment enforces the budget limits as hard constraints; and automatically terminating the sub-agent upon the earlier of: (i) the sub-agent transmitting a completion signal indicating its narrower subtask objective has been satisfied; or (ii) exhaustion of any one of the allocated budget limits, wherein upon budget-limit exhaustion the sub-agent transmits to the research agent any partial output produced together with a machine-readable indicator identifying which budget limit was exhausted; prior to decomposing the user request, retrieving from a memory device: (i) user metadata providing user-specified preferences and domain interests supplied during a prior configuration session; and (ii) user memory records synthesized records of prior interaction sessions stored by a memory-synthesis process in a user-specific database; incorporating the retrieved user metadata and user memory records into a research prompt inference process that generates a ranked list of topics of interest, wherein higher-ranked topics receive a greater share of research agent resources during parallel execution; and after transmitting the structured metadata to the user device, executing a memory-synthesis process that generates a memory object encoding queries made, outputs selected by the user, and inferred preferences from the session, and writing the memory object to the user-specific database in the memory device for retrieval during future sessions, wherein executing the plurality of research agents in parallel further includes: scheduling the research agents using at least one of a load-balancing algorithm, a priority-based scheduling algorithm, or a dependency-aware scheduling algorithm, wherein a research agent is designated as dependent if its subtask objective requires output produced by another research agent, and dependent research agents are instantiated only after receiving intermediate results from the research agents on which they depend; selecting, by each research agent in accordance with a tool-selection policy, at least one tool from a set of tools having a large language model query, a web search, an application programming interface call, or a database lookup, wherein the tool-selection policy applies at least one of relevance scoring, historical tool performance data, latency constraints, or cost constraints stored in memory to rank available tools; and routing intermediate results from each research agent to the orchestration module for caching in a shared memory store, such that intermediate results generated by one research agent are retrievable by other concurrently executing research agents to eliminate redundant tool invocations across the parallel agents; further includes: upon determining that an output of a feature-extraction process or a research agent fails to satisfy a predefined confidence threshold, instantiating in memory an ensemble reasoning cluster providing a plurality of sub-agents executing concurrently on the one or more processors, wherein each sub-agent of the ensemble receives the same input but operates under a distinct prompt configuration or language model configuration; aggregating outputs of the concurrently executing sub-agents of the ensemble using a heuristic combining procedure to produce a single aggregated output, wherein the heuristic combining procedure applies at least one of majority voting, confidence-weighted averaging, or cross-output consistency scoring to reduce output variance and hallucination probability; and substituting the aggregated output for the feature-extraction process output or research agent output in subsequent processing stages of the metadata extraction engine.

These and other features, aspects and advantages of the present subject disclosure will become better understood with reference to the following drawings, description and claims.

### BRIEF DESCRIPTION OF THE DRAWINGS

FIG. 1 is a schematic diagram illustrating the top-level components of an exemplary embodiment of the subject disclosure (colloquially known as “SnapNFind”) environment, including the user device, video, audio, text, and still image capture, edge processing, the Metadata EXtraction (MEX) Engine, feature extraction, orchestration, and compiled/formatted outputs, according to an embodiment of the subject disclosure.

FIG. 2 is a detailed diagram illustrating the MEX Engine edge processing modules, including fidelity qualifier, relevant window cropper, scene change detection, object detection, object key frame detection, according to an exemplary embodiment of the subject disclosure.

FIG. 3 is a detailed diagram illustrating the internal architecture of the MEX Engine, including input qualification, feature extraction, orchestration, research prompt inference, user metadata, user memories, memory maker, research agents, ensemble reasoning cluster, response compiler, and compiled/formatted outputs, according to an exemplary embodiment of the subject disclosure.

FIG. 4 is a detailed diagram illustrating the feature extraction module of the MEX Engine, including LLM feature analysis, image feature extraction, integrated feature extraction, and correlate/validate components, according to an exemplary embodiment of the subject disclosure.

FIG. 5 is a detailed diagram illustrating the orchestration and research agent subsystem, according to an exemplary embodiment of the subject disclosure.

FIG. 6 is a diagram illustrating the user experience flow and MEX Engine stream input/output, depicting the stepwise engine state model, according to an exemplary embodiment of the subject disclosure.

FIG. 7 is a schematic system diagram illustrating the computing environment of an exemplary embodiment of the subject disclosure.

FIG. 8 is a flowchart illustrating a method for retrieving metadata content of one or more multimedia content items using artificial intelligence, according to an exemplary embodiment of the subject disclosure.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

In the rapidly evolving landscape of digital media consumption, the demand for technologies that can efficiently analyze and interpret multimedia content has surged. As consumers increasingly engage with television, movies, and streaming services, there is a growing need for systems that can provide supplementary information about the content being viewed. This demand is driven by the shift towards on-demand and interactive experiences, where users seek immediate access to relevant data that enhances their engagement with the media.

The subject disclosure addresses these challenges by introducing a novel system and method for analyzing content using agent-based artificial intelligence. This system may be designed to integrate the analysis of visual, audio, still image, and textual data streams concurrently, thereby providing a more cohesive and efficient user experience. By leveraging advanced AI techniques, the system can rapidly interpret and verify content across various media formats, ensuring that users receive accurate and timely information.

Broadly, an embodiment of the subject disclosure provides a system and method for analyzing multimedia content using agent-based artificial intelligence. The system includes a user device or a server (via smart device) configured to capture video, audio, text, and still image inputs. It then performs edge processing to extract key input, via a server-based metadata extraction (MEX) engine. The MEX engine receives the key inputs, performs input qualification, extracts features using a hybrid approach combining Large Language Models and machine learning models, orchestrates research using agent-based AI to query various data sources, and compiles the research into human-readable metadata. The system integrates concurrent analysis of visual, audio, still image, and textual data streams to provide users with accurate, timely, and actionable information about multimedia content such as television programs, movies, and streaming services, and still images. The architecture is modular, extensible, and optimized for mobile devices, AR/VR headsets, other smart devices, and multimedia discovery interfaces.

### System Architecture

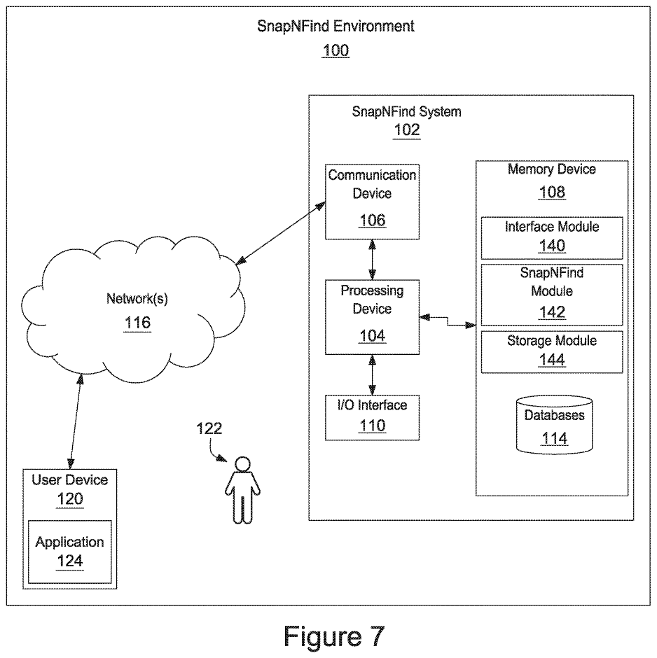

Referring now to FIG. 7, FIG. 7 illustrates a schematic architecture of an environment, hereinafter Architectural environment 100, according to aspects of the present disclosure. While FIG. 7 illustrates various components of the Architectural environment 100, additional components can be added, and existing components can be removed.

As illustrated in FIG. 7, system 102 includes one or more processing devices, herein processing device 104, coupled to a communication device 106. The processing device 104 may be also coupled to a memory device 108, and an input/output (I/O) interface 110. In embodiments, communication device 106 enables system 102 to communicate with other devices and systems via one or more networks 116. System 102 can communicate with a user device 120 via network 116. A user 122 can utilize the user device 120 to communicate with system 102.

The user device 120 can include one or more electronic devices such as a smartphone, a tablet computer, a laptop computer, a desktop computer, augmented reality (AR) headset, virtual reality (VR) headset, smart glasses, a thin client, a smart appliance, and the like. While FIG. 7 illustrates one user device 120, the Architectural environment 100 can include multiple user devices operated by the user 122 or operated by other users.

According to aspects of the present disclosure, system 102 enables the user 122, operating a copy of an application 124 executing on the user device 120, to communicate with the system 102 and leverage the services provided thereby. System 102 may be configured to retrieve content, or metadata, utilizing content signatures such as acoustic fingerprints, image fingerprints, video fingerprints, other multimedia content fingerprints, facial recognition, or object detection. System 102 provides content quickly and accurately regarding people, places, things, and other visual representations presented on television, movies, and streaming media, and still images.

To perform the processes described herein, system 102 can store and execute an Interface Module 140, a Processing Module 142, and a Storage Module 144. Interface Module 140, Processing Module 142, and Storage Module 144 can be stored in memory device 108. These modules can include the necessary logic, instructions, and/or programming to perform the processes and methods described in further detail below. The modules can be written in any suitable programming language.

In embodiments, application 124 can be a specifically designed application that operates with system 102 to perform the processes and methods described herein. In other embodiments, application 124 can be a third-party application, such as a web browser, that communicates with system 102 to perform the processes and methods described herein. The memory device 108 can also include one or more databases 114 that store information and data associated with the processes and methods described below in further detail.

### User Device and Initial Interaction

The subject disclosure uses an application that resides on the user device 120. The user device 120 can be a smartphone (Android, Apple IOS, and/or other Operating Systems), AR/VR headset, smart glasses, laptop, web camera, or any device capable of capturing video and audio inputs, as well as displaying structured or rich text output. The subject disclosure assumes basic interactivity via links, clickable/tappable suggestions, or voice response. The process begins after the user 122 opens application 124 and initiates a request (e.g., taps an icon, uses a voice assistant, taps a button, etc.).

### Video, Audio, Textual, and Image Capture via User Device

The subject disclosure requests permission to access the user device's camera and microphone. Once granted, the subject disclosure uses the user device's camera and microphone to simultaneously capture video, audio, still images, and text from the environment, such as a scene from a movie, TV show, still image, or live event. This initiates user query and video and audio input as described below:

User Query (Optional and Ongoing): User queries may be initiated by operatively associating the user device 120 with a media source. In one embodiment, the user device 120 may be pointed at a TV or streaming media and then clicking/snapping a button (e.g. a “SnapNFind button”). It is noted that any known or not-yet developed means of the user device 120 capturing content of the media source is contemplated by the subject disclosure.

User queries may also be submitted at the start of a session (“session initiation”) or anytime thereafter, wherein a session embodies capture of input from the one or more media source. The user queries may be text-based or spoken (with optional on-device or server-side transcription) or conveyed through other means. These are processed by the MEX Engine in tandem with video content.

Video and Audio Input (Session Initiation): Input from a media source (in one embodiment, a brief video clip) initiates the session. This could be as little as a few seconds, capturing a scene of interest. Upon initiation by the user device 120, the subject disclosure may begin analysis without any additional explicit user input, or viewing interruption,

### Edge Processing

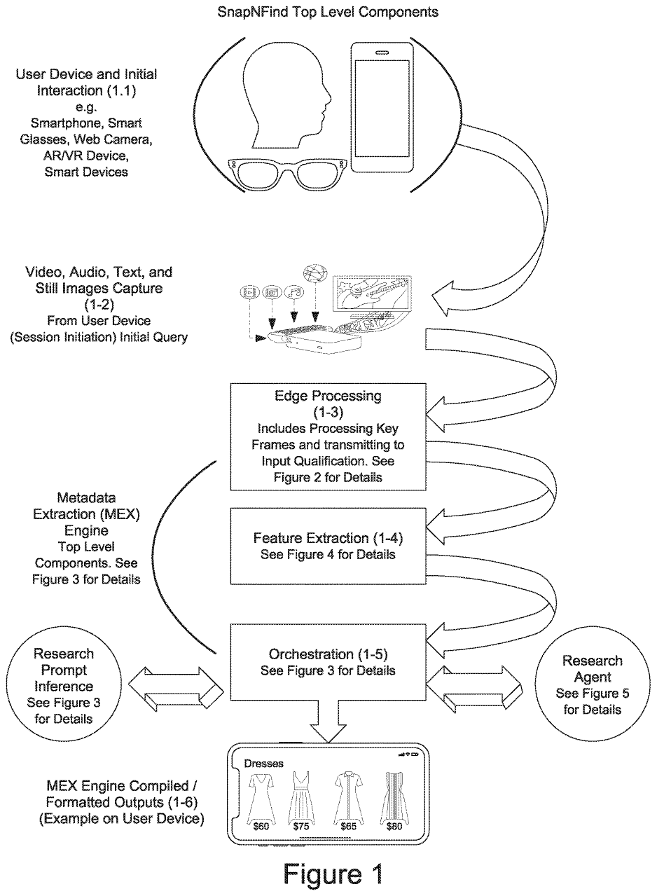

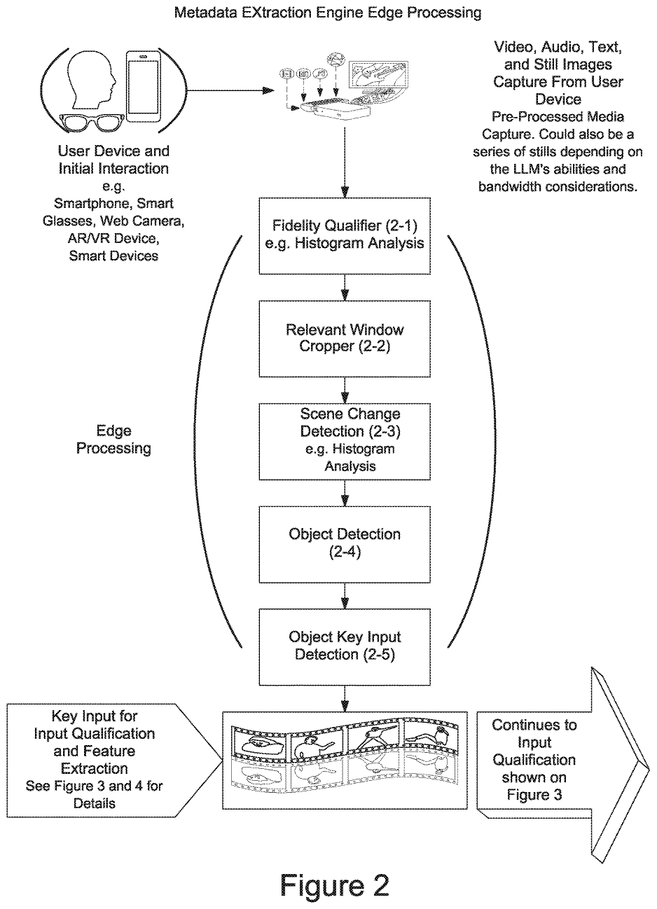

Referring to FIGS. 1 and 2, Edge Processing includes five principal modules as shown below:

Fidelity Qualifier (FIG. 2-1): Evaluates input quality and filters out low-fidelity video, still images, and audio to ensure that only high-quality input may be processed further.

Relevant Window Cropper (FIG. 2-2): Crops key region of interest (i.e., the video or still image), removing irrelevant background areas to focus processing resources on the relevant content.

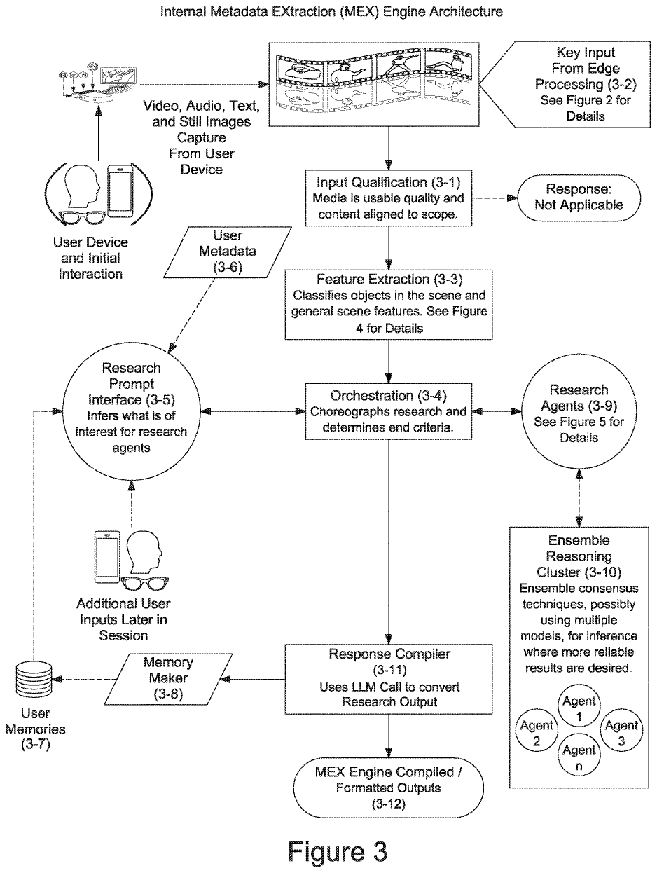

Scene Change Detection (FIG. 2-3): Detects major visual transitions or cuts between different video scenes to identify distinct content segments.

Object Detection (FIG. 2-4): Locates and labels objects within each window using machine learning models.

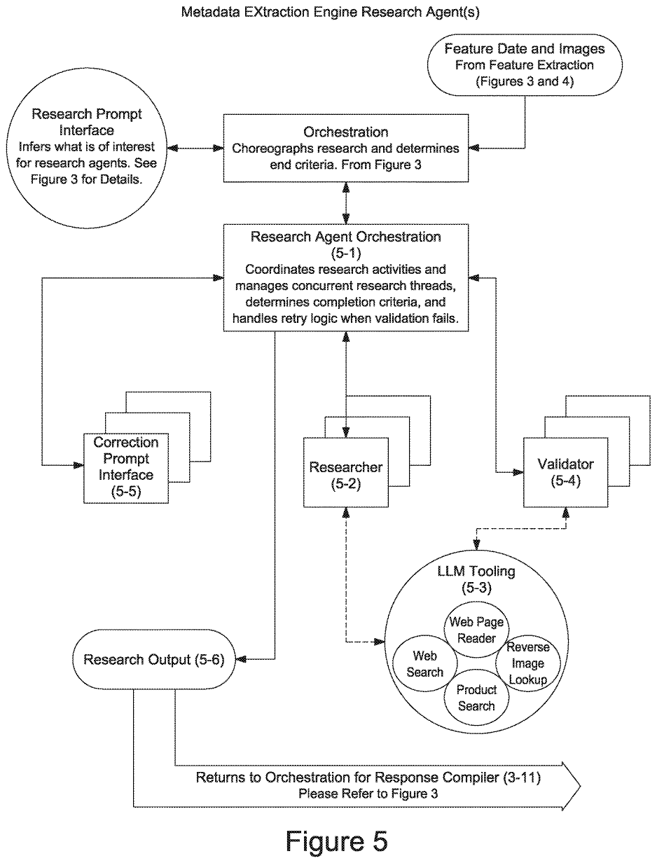

Object Key Frame/Input Detection (FIG. 2-5): Selects the clearest, most representative frames/inputs (e.g., those containing objects of interest per the user's settings or preference) for server-side analysis.

Audio processing handles transcription when applicable. Following Edge Processing, the key inputs are transmitted to Input Qualification for further processing and Feature Extraction.

### Metadata Extraction (MEX) Engine

Referring to FIGS. 1 and 3, the subject disclosure processes video, still images, text, and audio in real time or near-real time, using a combination of Edge Processing and the Metadata EXtraction (MEX) Engine, the primary component of the Architectural environment. The MEX Engine may be a modular, agent-based reasoning (i.e., agentic AI) architecture integrating Large Language Models (LLMs) and machine learning (ML) models, such as convolutional neural networks for video and audio spectrogram analysis.

MEX Engine external data resources could include, but are not limited to: search engines for general-purpose content retrieval; third-party Application Programming Interfaces (APIs) (e.g., weather, product databases, or film industry APIs); online data sources such as structured datasets like Electronic Program Guides (EPGs); bespoke data sources having curated internal or partner-provided datasets tailored to domain-specific deployments (e.g., sports metadata); and blockchain for confirming transactions without needing a central authority and for data storage (e.g., FileCoin).

### Input Qualification

As shown in FIG. 3-1, Input Qualification processes the key input from Edge Processing. It validates the useability and relevance of the key input, rejects low-quality video and/or still images, and determines whether the scene in the key input is a video capturing some sort of recorded or live video media, (e.g., TV), a still image, and/or text. Input Qualification may also involve bespoke qualification criteria as per the user's settings. For example, a sports application may limit queries to sports media only.

### Feature Extraction

Referring to FIGS. 1-4, 3-3, and FIG. 4, Feature Extraction receives the key input from Input Qualification and employs a hybrid approach using both LLM feature analysis and ML-based object (image) detection to isolate and extract people, places, and objects/things for research. Feature Extraction identifies attributes such as time of day, type of location, people, clothing, other items, and environmental features. It may also include activity-based, temporal, and movement features. Feature Extraction sends processed data to Orchestration for further research by Research Agents and Orchestration dynamically generates Research Agents to perform the following functions:

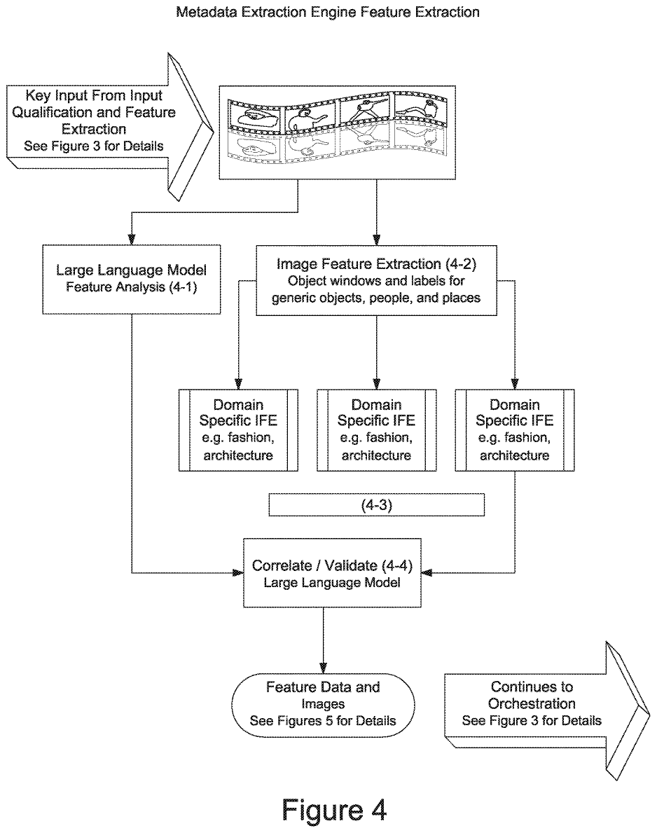

Large Language Model Feature Analysis (FIG. 4-1): LLMs are used to analyze the text, audio, still images, and video frames and describe the scene and features contained in that input. This provides a high-level semantic understanding of the content.

Image Feature Extraction (IFE) (FIG. 4-2): IFE processes object windows and labels for generic objects and people using models such as You Only Look Once (YOLO) or Bootstrapped Language-Image Pretraining (BLIP) models. IFE may also use domain-specific and/or specialized Integrated Feature Extraction modules (FIG. 4-3) for vertical domains (e.g., fashion, architecture).

Correlate/Validate (FIG. 4-4): An LLM-based component correlates features from the LLM Feature Analysis with the extracted images to ensure consistency and accuracy.

### Ensemble Reasoning Cluster

As shown in FIG. 3-10, if the Feature Extraction result is not satisfactory, Ensemble Reasoning Cluster coding may be used in addition to Research Agents to improve result accuracy. LLM ensemble architectures may be used to improve accuracy. For a given singular task, the governing agent dynamically generates multiple LLM sub-agents (using different prompts and/or models) to run in parallel. The governing agent selects or combines the LLM sub-agents' outputs using various heuristics to reduce hallucination and improve fidelity. In practice, any of the nodes in the MEX Engine that employs an LLM for research or decision making can be made into an ensemble to potentially improve its outcome, with tradeoffs of complexity and cost.

### Orchestration

Referring to FIGS. 1-5, 3-4, and FIG. 5, Orchestration choreographs research and determines end criteria, and may be an LLM-based agent (i.e., graph-based agentic AI) that performs the following: Determines the research topic (“the item of interest” per the user's setting), dynamically generates Research Agents, coordinates Research Agents, normalizes outputs, checks for consistency, and applies contextual confidence weighting of results based on user-specific settings or historical user behavior

Orchestration also coordinates input from Research Prompt Inference to determine features and items of interest per the user's settings and generates a list of topics to research. Orchestration then dynamically generates LLM-based Research Agents for each of the items of interest. The Research Agents query LLMs, search engines, APIs, and other data sources. As per agentic programming models, LLMs are used as composable micro-agents combined with trigger detection to invoke external activities such as web searches.

Additionally, Orchestration performs dynamic task decomposition to concurrently integrate analysis of audio, video, text, and still images using an agent-based artificial intelligence framework, wherein the orchestration includes: inferring one or more topics of interest based on the extracted features and the user-specific settings/preferences, decomposing a user request into a plurality of subtasks based on the inferred topics of interest, and dynamically generating, for each subtask, a research agent configured with a subtask-specific objective;

As examples, if the input contains video, Orchestration dynamically generates a Vision Agent and an Audio Agent. If the audio contains speech, Orchestration dynamically generates a Speech-to-Text Agent. If the text contains ambiguous references (“that object”, “this sound”), Orchestration dynamically generates Cross-Modal Alignment Agents. Orchestration is not static; it dynamically reacts to the input/content.

Orchestration also determines when sufficient data is collected, and when the MEX Engine can proceed to compiling and formatting outputs and eventually the steady state.

### Research Prompt Inference

As shown in FIG. 3-5, Research Prompt Inference infers what is of interest for Research Agents and generates topics for further research. It considers inputs such as those representing information known about the user from previous input, including User Metadata and User Memories.

### User Metadata and User Memories

User Metadata (FIG. 3-6): User Metadata may be supplied by the user during initial setup or via preference selection to assist in targeting responses (e.g., interested in fashion, sports, and cinema). Metadata guides personalization of research, analyses, and responses. The user is not required to supply metadata.

User Memories (FIG. 3-7): A dynamic user-specific database of past interactions, selections, and inferred interests. Used to tailor system behavior and prioritize relevant outputs.

### Memory Maker

As shown in FIG. 3-8, Memory Maker synthesizes a memory object from session activity. It stores information about queries made, chosen responses, and inferred preferences in the User Memories database. This allows for session summaries and cross-session training. Memory Maker can be turned off/on by the user and/or updated live as the session continues or post-hoc.

### Research Agents

Referring to FIG. 3-9 and FIG. 5, the Research Agent subsystem is a self-correcting research architecture that transforms extracted features into validated metadata through iterative investigation and refinement. This closed-loop architecture ensures high-quality research results through continuous refinement while maintaining efficiency through parallel processing and intelligent tool selection.

Each Research Agent may be dynamically generated by the Orchestration module to investigate a specific topic of interest, per the user's setting or preferences. Multiple Research Agents can operate in parallel, significantly reducing the overall time required to gather information. Generating the Research Agents in parallel includes scheduling the Research Agents using a load-balancing, priority-based, or dependency-aware scheduling algorithm.

The Orchestration module decomposes the user request into a plurality of subtasks and dynamically generates a corresponding Research Agent for each subtask. Each Research Agent may be configured with a subtask-specific objective. For example, The Vision Agent handles object detection, scene segmentation, facial expression analysis, motion tracking, Optical Character Recognition (OCR) (text inside images), and visual event detection. This output becomes a knowledge substrate for other agents. As an additional example, the Audio Agent runs in parallel and performs speech recognition, speaker identification, emotion/tone detection, environmental sound classification, and music/soundtrack analysis. This gives the system temporal context that visuals alone cannot provide. Another example is the Text Agent, which may process user instructions, on-screen text (from OCR), speech transcripts, metadata, and prior conversation context. The Text Agent performs intent extraction, entity linking, temporal reasoning, and narrative reconstruction. The Text Agent may be the “semantic glue” binding things together.

One of the more important Research Agent may be the Cross-Modal Fusion Agent. The Cross-Modal Fusion Agent performs multimodal alignment by correlating visual events with audio timestamps, speech references with objects (“that car” infers the red sedan in frame 3), emotional tone with facial expressions, and scene changes with narrative structure. Cross-Modal Fusion Agents may resolve contradictions such as: audio says “siren” but no emergency vehicle is visible; may infer an off-screen source, and vision sees a person smiling, but audio tone is sad; it infers masking or sarcasm. The Cross-Modal Fusion Agent produces a unified representation of the input. Other representative Research Agents can include sub-agents for specialized tasks. Depending on the scenario, the system may dynamically generate Safety Agents (to detect hazards, violence, accidents), Narrative Agents (to summarize events, generate explanations), Prediction Agents (to forecast next actions or risks), Retrieval Agents (pull background knowledge from APIs or databases). All of these are examples of the system spawning dynamic sub-agents based on multimodal cues.

The Research Agents employ tool selection logic that includes relevance scoring, historical tool performance, latency constraints, or cost constraints. These tools may include a combination of LLM queries, web searches, API calls, and database lookups.

Research Agents evaluate or refine results in a novel approach that includes operating in parallel and using a recursive agent-correlation algorithm. The recursive agent-correlation algorithm executes the plurality of research agents in parallel, each research agent configured to: perform subtask-specific analysis using one or more tools or external resources, generate intermediate results and transmit the intermediate results to an Orchestration module, evaluate its own progress using at least one evaluation criterion including a confidence metric, a completeness metric, or an uncertainty metric. This may be a looping, self-correcting process where multiple agents continuously compare, refine, and align their outputs, dynamically generating new agents when needed, until the system reaches a coherent, high-confidence interpretation of multimodal data.

This algorithm is important because it may be procedural, meaning the logic is implemented as explicit, inspectable algorithms that run at inference time versus “weighted” wherein the logic is hidden inside neural network parameters. The recursive agent-correlation algorithm may also be dynamic (adapts to content), Research Agent-driven (not a single model), iterative (runs multiple refinement cycles), tool-integrated (can call APIs, search databases and other data stores), and explainable (each step is logged and inspectable). The subject disclosure reasons across modalities through explicit, recursive coordination.

Each Research Agent selects, based on a tool-selection policy, at least one tool from a plurality of tools including a LLM query, a web search, and application programming interface call, or a database lookup. They generate an intermediate result using the selected tool and evaluate the intermediate result using at least one evaluation criterion. The evaluation criterion may provide a confidence score (wherein the valuation criteria are derived through explicit, multi-signal, cross-modal, task-aware procedures that allow the subject disclosure to self-correct, dynamically generate new agents, and converge on a high-confidence interpretation), completeness metric, or uncertainty metric. The evaluation criteria are derived through explicit, multi-signal, cross-modal, task-aware procedures that allow the subject disclosure to self-correct, dynamically generate new agents, and converge on a high-confidence interpretation.

If the evaluation criterion indicates insufficient completeness or accuracy, the Research Agent will dynamically generate at least one independent sub-agent having a narrower objective derived from the Research Agent's objective. Dynamic generation of the sub-agent may be triggered when the confidence score associated with the intermediate result falls below a threshold. Dynamically generating the sub-agent that provides allocating a computational budget including token limits, execution time limits, or tool-usage limits. The sub-agent may be terminated automatically upon satisfying a completion condition.

When the Research Agent receives the output from the sub-agent, it iteratively refines the intermediate result based on that output. Iterative refinement includes expanding a search query based on semantic analysis of the intermediate result, including keyword extraction, topic drift detection, or relevance scoring, as well as applying the above-mentioned evaluation criterion. The Research Agents exchange intermediate results via the Orchestration module to reduce redundant computation. Sharing intermediate results through Orchestration reduces redundant computation by ensuring that expensive operations (search, analysis, extraction, reasoning) are performed once, cached centrally, and reused by all agents, rather than repeated independently by each agent.

The Research Agent then transmits the completed subtask results to the Response Compiler. The Research Agent knows the subtask results are complete when it satisfies its task contract, achieves high confidence, meets completeness requirements, resolves uncertainties, aligns with other agents' outputs, and passes the Orchestrator's global memory checks. Only then does it hand off results to the Response Compiler. Multiple Research Agents can operate in parallel, significantly reducing the overall time required to gather information.

### Response Compiler

As shown in FIG. 3-11, Orchestrator transmits a completed subtask result to the Response Compiler. The Research Compiler normalizes heterogeneous Research Agent outputs and compiles the subtask results into a unified schema prior to generating the final response using an LLM call to convert the raw research output into a single, concise, and human-readable report. This may include hyperlinks, rich text, digital media, or instructions meant to be interpreted by the client application (e.g., region of interest represented as a box at specified coordinates).

### Mex Engine Compiled/formatted Outputs

As shown in FIGS. 1-6 and 3-12, rich text responses and clickable intents are returned to the user device for display. These may include factual metadata (e.g., actor names, clothing brands), inferred context, and links to further content, such as alternative content. The MEX Engine can extract a rich array of features from the captured medium including both features explicitly about the medium such as objects and their relationships, and further information about these features that can be determined from external research such as web searches.

For example, a video might show a man and a woman having a conversation in a sunny beach scene. The MEX Engine would report not just those details, but also the names of the actors, the movie itself, the brands of the clothes they are wearing and where to buy them, similar alternatives, the location and nearby hotels, and so on.

### User Experience Flow and Mex Engine Stream I/O

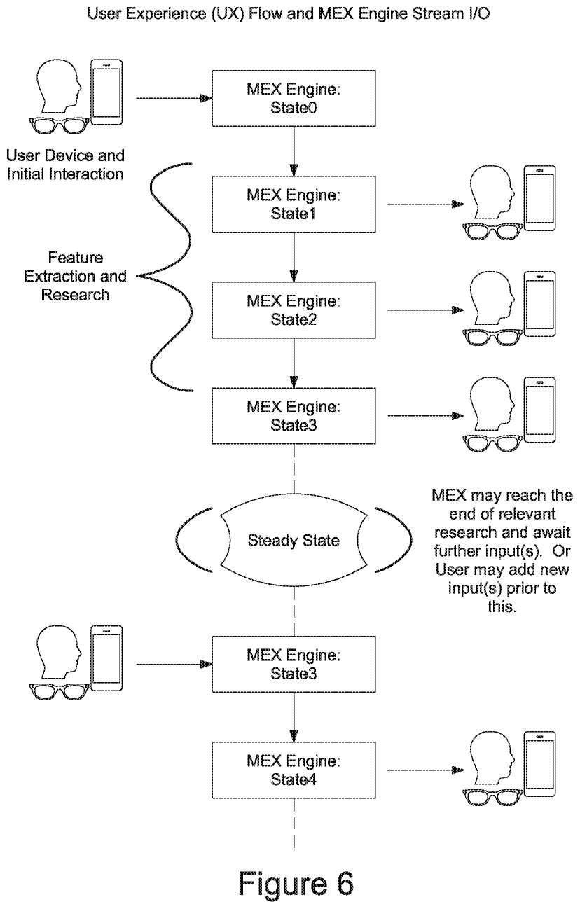

Referring to FIG. 6, the systemic experience may be built around a stepwise engine state model. The MEX Engine moves through distinct states in response to user queries and its internal research. For a single media capture session, each subsequent state may involve outputs from the engine's research or additional input queries from the user, thereby facilitating a dynamic conversational experience.

State represents the accumulation of potentially relevant information from the AI agents' research together with the inputs from the user. At each change of state, research may potentially be sent as a response to the user. At one point, the research gathered may be deemed sufficient for the current user inputs and the process paused (steady state) until additional inputs trigger further research. The user experience may be designed to support long-form engagement or quick single-query sessions.

### Processing Device

The processing device 104 can be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. While FIG. 7 illustrates a single processing device 104, system 102 can include multiple processing devices 104, whether of the same type or different types.

### Memory Device

The memory device 108 can be and/or include computerized storage medium capable of storing electronic data temporarily, semi-permanently, or permanently. The memory device 108 can be or include a computer processing unit register, a cache memory, a magnetic disk, an optical disk, a solid-state drive, and so forth. The memory device can be and/or include random access memory (RAM), read-only memory (ROM), static RAM, dynamic RAM, masked ROM, programmable ROM, erasable and programmable ROM, electrically erasable and programmable ROM, and so forth. While FIG. 7 illustrates a single memory device 108, the System 102 can include multiple memory devices 108, whether of the same type or different types.

### Communication Device

Communication device 106 enables system 102 to communicate with other devices and systems. Communication device 106 can include, for example, a networking chip, one or more antennas, and/or one or more communication ports. The communication device 106 can generate radio frequency (RF) signals and transmit the RF signals via one or more of the antennas. The communication device 106 can generate electronic signals and transmit electronic signals via one or more of the communication ports.

The communication device 106 can include hardware and/or software for generating and communicating signals over a direct and/or indirect network communication link. A direct link can include a link between two devices where information is communicated from one device to the other without passing through an intermediary. For example, the direct link can include a Bluetooth connection, a Zigbee connection, a WiFi Direct connection, a near-field communications (NFC) connection, an infrared connection, a wired universal serial bus (USB) connection, an ethernet cable connection, a fiber-optic connection, a firewire connection, a microwire connection, and so forth.

An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. Cellular network connection can be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long-term evolution (LTE) standard, and so forth.

### Cloud Service Implementation

As described above, system 102 can include hardware components to perform the processes described herein. In embodiments, one or more components, hardware, and/or functionality of the System 102 can be hosted and/or instantiated on a cloud or cloud service. A cloud or cloud service can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine.

### Method of Retrieving Metadata Content

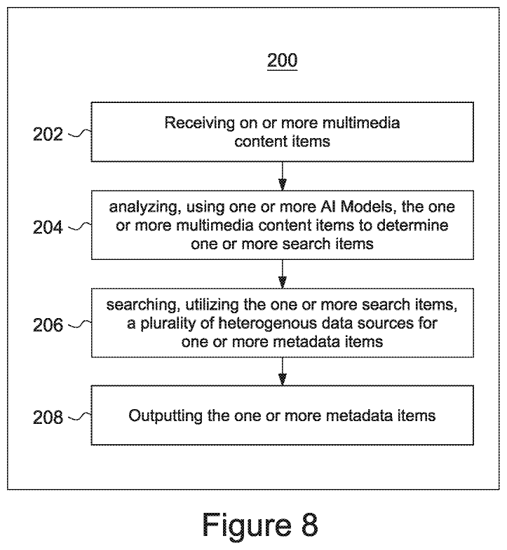

FIG. 8 illustrates a method 200 for retrieving metadata content, according to aspects of the present disclosure. While FIG. 8 illustrates various stages of the method 200, additional stages can be added, and existing stages can be removed and/or reordered.

The method 200 begins with step 202, which involves receiving one or more multimedia content items. In embodiments, the one or more multimedia content items can be received through one or more I/O devices running on user device 120. The content can include various forms such as video, audio, textual, or still images, which are then processed by system 102, preferably using Processing Module 142. This step is significant as the process may be initiated by capturing the multimedia content that will be analyzed.

In step 204, the received multimedia content items are analyzed using one or more AI models to determine one or more search items. This analysis represents a significant advancement, utilizing advanced AI techniques to extract relevant features or signatures from the multimedia content. These features may include acoustic fingerprints, image fingerprints, facial recognition data, or other identifiable elements that can be used to search for related information. The analysis employs edge processing and server-based feature extraction using Large Language Models and machine learning models.

Step 206 involves matching the determined search items with a plurality of information data sources to retrieve one or more metadata items. This step highlights system 102's ability to interact with various data sources, such as databases 114, search engines, third-party APIs, or online platforms, to find metadata that corresponds to the search items. The matching process may utilize techniques like exact or fuzzy matching and/or any known or future search tools present in AI systems to ensure comprehensive retrieval of relevant metadata.

Step 208 proceeds to output one or more metadata items. This step may be significant as this action delivers the processed information back to the user, providing insights such as the title, product details, actor names, purchasing information, or other relevant data about the multimedia content. The output can be presented in a user-friendly format, enhancing the overall user experience by offering quick and accurate information retrieval.

### Additional Embodiments and Variations

The processing device 104, the communication device 106, the memory device 108, and the I/O interface 110 can be interconnected via a system bus. The systemic bus can be and/or include a control bus, a data bus, and address bus, and so forth. The processing device 104 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and so forth. As used herein, “processor,” “processing component,” “processing device,” and/or “processing unit” can be used generically to refer to any or all the aforementioned specific devices, elements, and/or features of the processing device. While FIG. 7 illustrates a single processing device 104, system 102 can include multiple processing devices 104, whether the same type or different types.

The memory device 108 can be and/or include computerized storage medium capable of storing electronic data temporarily, semi-permanently, or permanently. The memory device 108 can be or include a computer processing unit register, a cache memory, a magnetic disk, an optical disk, a solid-state drive, and so forth. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all the aforementioned specific devices, elements, and/or features of the memory device. While FIG. 7 illustrates a single memory device 108, system 102 can include multiple memory devices 108, whether the same type or different types.

Communication device 106 enables system 102 to communicate with other devices and systems. Communication device 106 can include, for example, a networking chip, one or more antennas, and/or one or more communication ports. The communication device 106 can generate radio frequency (RF) signals and transmit the RF signals via one or more of the antennas. Communication device 106 can generate electronic signals and transmit the RF signals via one or more of the communication ports. The communication device 106 can receive the RF signals from one or more of the communication ports. The electronic signals can be transmitted to and/or from a communication hardline by the communication ports. The communication device 106 can generate optical signals and transmit the optical signals to one or more of the communication ports. The communication device 106 can receive the optical signals and/or can generate one or more digital signals based on the optical signals. The optical signals can be transmitted to and/or received from a communication hardline by the communication port, and/or the optical signals can be transmitted and/or received across open space by the communication device 106.

The communication device 106 can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

System 102 can communicate with one or more network resources via network 116. The one or more network resources can include external databases, social media platforms, search engines, file servers, web servers, or any type of computerized resource that can communicate with the System 102 via the network 116.

As described above, system 102 can include hardware components to perform the processes described herein. In embodiments, one or more of components, hardware, and/or functionality of system 102 can be hosted and/or instantiated on a “cloud” or “cloud service.” As used herein, a “cloud” or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In some embodiments, the components and functionality of the System 102 can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

In various embodiments, Interface Module 140 can implement non-haptic activation (e.g., voice control and the like) into the interfaces provided. For example, the user can navigate the interfaces of system 102 using the audio input device of the user device 120. Interface Module 140 can implement one or more chat-bots to deliver conversational input and output to a user.

In some embodiments, Processing Module 142 includes one or more Artificial Intelligence (AI) modules, or models, configured to analyze multimedia content captured by the user 122, using application 124 running on user device 120. User 122 initiates capture of content, such as multimedia content, i.e., video, audio, still image, and/or other multimedia content known in the art, using an interface provided by Interface Module 140.

In response to capture initiation, user device 120, through one or more I/O devices, such as a camera, microphone, voice, etc., may capture one or more multimedia content items. Processing Module 142 analyzes one or more multimedia content items, using one or more AI modules, to determine one or more content signatures, usable for searching for content related to the one or more multimedia content items.

Using one or more content signatures, one or more AI modules can search for content related to one or more multimedia content items. In embodiments, searching can be performed through one or more distributed search engines, having heterogeneous content items, and can utilize exact matching, fuzzy matching, and/or other known search tools present in AI systems. In embodiments, content related to one or more multimedia content items is returned to user 122 for consumption

Various aspects of the systems described herein can be referred to as “information,” “content,” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine-state that is computer-readable. Content and/or data can refer to human-readable text.

Various of the devices in the Architectural environment 100, including the System 102 and/or the user device 120 can provide I/O devices for outputting information in a format perceptible by a user and receiving input from the user. For example, the System 102 can communicate with the I/O devices via the I/O interface 110. The I/O devices can display graphical user interfaces (“GUIs”) generated by the System 102. The I/O devices can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The I/O devices can include an acoustic element such as a speaker, a microphone, and so forth. The I/O devices can include a button, a switch, a keyboard, a touch-sensitive surface, a touchscreen, a camera, a fingerprint scanner, and so forth. The touchscreen can include a resistive touchscreen, a capacitive touchscreen, and so forth.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

It should be understood, of course, that the foregoing relates to exemplary embodiments of the subject disclosure and that modifications may be made without departing from the spirit and scope of the subject disclosure as set forth in the following claims.

1. A system for analyzing multimedia content using artificial intelligence, wherein the system is implemented on a non-transitory computer-readable medium storing instructions that, when executed by one or more processors, the system comprises:
a user device provides user settings, the user device configured to capture multimedia input and generate a user request;
a server-based metadata extraction engine in communication with the user device, the metadata extraction engine configured to:
perform edge processing on the multimedia input to generate one or more key inputs,
extract features from the one or more key inputs;
orchestrate research using agent-based artificial intelligence, wherein said orchestration comprises:
inferring topics of interest based on the user settings regarding the extracted features;
decomposing the user request into a plurality of subtasks based on said topics of interest;
dynamically generating a research agent for each subtask, wherein each research agent is configured with a subtask specific objective; and
wherein each research agent executes in parallel with each of remaining research agents.

2. The system of claim 1, wherein extracting features from the one or more key inputs comprises:
concurrently executing, on one or more processors and using one or more key inputs selected from the multimedia input as a common input, (i) a first feature-extraction process comprising a Large Language Model (LLM) that generates a natural-language scene description identifying objects, people, actions, and contextual relationships present in the one or more key inputs, and (ii) a second feature-extraction process comprising one or more computer-vision machine-learning models that generate object bounding-box windows and associated semantic labels for generic objects, people, and places within the one or more key inputs;
applying, for at least one vertical domain specified in the user settings, one or more domain-specific integrated feature-extraction modules to the one or more key inputs to generate domain-specific feature data that supplements the semantic labels produced by the second feature-extraction process; and
executing a cross-validation process, implemented by a second LLM call, that (i) receives as input both the natural-language scene description generated by the first feature-extraction process and the domain-specific feature data and object labels generated by the second feature-extraction process and the domain-specific modules, (ii) identifies any conflicts or inconsistencies between the two sets of outputs, (iii) resolves such conflicts by applying contextual reasoning to produce a single, reconciled set of feature data, and (iv) outputs the reconciled feature data to the orchestration component for use in subtask decomposition.

3. The system of claim 2, wherein the one or more computer-vision machine-learning models comprise at least one bootstrapping language-image pre-training (BLIP) model or equivalent vision-language model trained to generate paired image-caption representations, and wherein the cross-validation process further:
quantifies a consistency score between the natural-language scene description and the object labels by computing a semantic similarity metric; and
flags, in a structured data record associated with the reconciled feature data, any feature for which the consistency score falls below a predefined confidence threshold, thereby providing the orchestration component with a machine-readable indication of low-confidence features that may require additional research agent investigation.

4. The system of claim 1, wherein decomposing the user request into a plurality of subtasks prior to dynamically generating any research agent comprises:
generating, by the orchestration component and for each topic of interest inferred from the reconciled feature data and the user settings, a subtask specification record stored in memory, wherein each subtask specification record comprises: (i) a subtask objective field encoding a natural-language description of the specific information to be retrieved or analyzed for that topic; (ii) a modality-type tag identifying whether the subtask pertains to visual data, audio data, textual data, or a cross-modal combination thereof; (iii) a tool-selection policy field specifying a ranked list of permitted tools selected from LLM queries, web searches, application programming interface calls, and database lookups and based on at least one of relevance scoring, historical tool performance data, latency constraints, and cost constraints associated with the user settings; and (iv) a scheduling-priority value derived from at least one of topic confidence, user-preference weighting, and inter-subtask dependency relationships;
evaluating inter-subtask dependency relationships among the plurality of subtask specification records to identify any ordering constraints, wherein a subtask specification record is flagged as dependent if its subtask objective requires output produced by another subtask; and
only after generating and evaluating all subtask specification records, instantiating a corresponding research agent for each subtask specification record in accordance with the scheduling-priority values and dependency constraints, wherein research agents for independent subtasks are instantiated concurrently and research agents for dependent subtasks are instantiated only after the subtasks on which they depend have transmitted their intermediate results to the orchestration module.

5. The system of claim 4, wherein generating the subtask specification records further comprises:
determining, based on the modality-type tag of each subtask specification record, whether the subtask requires a modality-specific agent type selected from: a Vision Agent configured for object detection, scene segmentation, facial expression analysis, motion tracking, and optical character recognition; an Audio Agent configured for speech recognition, speaker identification, emotion and tone detection, environmental sound classification, and music analysis; a Text Agent configured for intent extraction, entity linking, temporal reasoning, and narrative reconstruction; or a Cross-Modal Fusion Agent configured to correlate visual events with audio timestamps, speech references with visual objects, and emotional tone with facial expression data; and
recording the determined agent type in the subtask specification record such that the orchestration component instantiates a research agent of the determined agent type when processing the subtask specification record.

6. The system of claim 1, wherein each research agent is further configured to:
generate an intermediate result by executing one or more tools selected in accordance with the tool-selection policy of the research agent's corresponding subtask specification record;
evaluate the intermediate result against at least one evaluation criterion comprising: (i) a confidence score computed as a function of cross-source agreement between results returned by at least two distinct tool invocations; (ii) a completeness metric computed as the ratio of subtask-objective information fields that have been populated to the total number of such fields defined in the subtask specification record; and (iii) an uncertainty metric derived from the variance or entropy of the intermediate result across multiple LLM sampling runs or tool calls;
determine, by comparing each evaluation criterion against a corresponding predefined threshold, whether the intermediate result satisfies a sufficiency condition; and
only upon determining that the confidence score falls below a confidence threshold, that the completeness metric falls below a required coverage level, or that the uncertainty metric exceeds an uncertainty ceiling, dynamically generate at least one independent sub-agent, wherein: (i) the sub-agent is assigned a narrower subtask objective algorithmically derived from the research agent's subtask objective by identifying the specific information field or fields that caused the sufficiency condition to fail; and (ii) the sub-agent executes independently and returns its output to the research agent for iterative refinement of the intermediate result.

7. The system of claim 6, wherein the research agent is further configured to:
upon receiving output from the at least one sub-agent, re-evaluate the updated intermediate result against the evaluation criteria; and
continue generating additional sub-agents and performing iterative refinement until the sufficiency condition is satisfied or a maximum iteration count is reached, at which point the research agent transmits the most recent intermediate result to the orchestration module with a machine-readable flag indicating whether the sufficiency condition was satisfied or the maximum iteration count was reached;
wherein each iteration of sub-agent generation uses a search query expansion procedure that applies at least one of keyword extraction, topic-drift detection, and relevance scoring to the prior intermediate result to formulate a refined query that differs from prior queries issued by the research agent or any of its sub-agents.

8. The system of claim 6, wherein dynamically generating the at least one independent sub-agent further comprises:
allocating, by the orchestration module at the time of sub-agent instantiation, a computational budget for the sub-agent, wherein the computational budget comprises at least one of: (i) a token limit specifying a maximum number of LLM-inference tokens the sub-agent may consume across all of its LLM calls; (ii) an execution time limit specifying a wall-clock deadline after which the sub-agent is automatically terminated if the sub-agent has not transmitted a completion signal; and (iii) a tool-usage limit specifying a maximum number of tool invocations aggregated across LLM queries, web searches, API calls, and database lookups that the sub-agent may perform;
encoding the allocated computational budget into the sub-agent's runtime configuration at instantiation such that the sub-agent's execution environment enforces the budget limits as hard constraints rather than advisory limits; and
automatically terminating the sub-agent upon the earlier of: (i) transmission by the sub-agent of a completion signal indicating that its narrower subtask objective has been satisfied, or (ii) exhaustion of any one of the allocated token limit, execution time limit, or tool-usage limit, wherein upon termination by resource exhaustion the sub-agent transmits to the research agent whatever partial output it has produced together with a machine-readable indicator identifying which budget limit was exhausted.

9. The system of claim 8, wherein the orchestration module determines the computational budget allocated to each sub-agent by:
retrieving a remaining global computational budget for the current user session, wherein the global computational budget tracks aggregate token consumption, elapsed execution time, and tool-usage counts across all research agents and sub-agents instantiated during the session;
computing a per-sub-agent budget allocation as a function of: (i) the priority value of the parent research agent's subtask specification record; (ii) the estimated complexity of the narrower subtask objective assigned to the sub-agent, as estimated by the orchestration module using a trained cost-prediction model; and (iii) the remaining global computational budget, such that higher-priority subtasks receive a proportionally larger allocation and no single sub-agent allocation exceeds a predefined fraction of the remaining global budget; and
updating the remaining global computational budget in real time as each research agent and sub-agent consumes resources, thereby preventing the aggregate resource consumption of all concurrently executing agents from exceeding a session-level computational ceiling.

10. A system for analyzing multimedia content using agent-based artificial intelligence, wherein the system is implemented on a non-transitory computer-readable medium storing instructions that, when executed by one or more processors, the system comprises:
a user device having user-specific settings/preferences, the user device configured to capture multimedia input and generate a user request;
a server-based metadata extraction engine receiving, from the user device, multimodal input comprising at least one of image data, video data, audio data, or textual data, the user device further providing user-specific settings; extracting modality-specific features from the multimodal input using a metadata extraction engine, the metadata extraction engine configured to:
perform edge processing on the multimedia input to generate one or more key inputs,
extract features from the one or more key inputs
orchestrate analysis and research using an agent-based artificial intelligence framework, wherein said orchestration comprises:
inferring one or more topics of interest based on the extracted features and the user-specific settings/preferences;
decomposing the user request into a plurality of subtasks based on the inferred topics of interest;
dynamically generating a research agent for each subtask, wherein each research agent is configured with a subtask specific objective;
executing the plurality of research agents in parallel pipelines, each pipeline corresponding to a different modality or subtask category, each research agent configured to:
perform subtask-specific analysis using one or more tools or external resources;
generate intermediate results and transmit the intermediate results to an Orchestration module;
evaluate its own progress using at least one evaluation criterion comprising a confidence metric, a completeness metric, or an uncertainty metric;
wherein the Orchestration module is further configured to:
compare intermediate results across the plurality of research agents;
perform uncertainty-driven refinement, dynamically generating subagents when a Research Agent detects inconsistencies, omissions, or cross-modal conflicts among the intermediate results;
perform multimodal alignment by correlating visual features, audio features, and textual features based on temporal, spatial, or semantic relationships
perform intermediate result caching such that results from prior refinement cycles are reused during subsequent refinement cycles;
initiate one or more uncertainty-driven refinement cycles by directing at least one research agent to re-analyze data, expand its search, or generate a sub-agent to resolve the detected inconsistency;
repeat the refinement cycles until the evaluation criteria satisfy a convergence condition indicating that the subtasks are complete based on explicit stop conditions comprising: (a) a confidence metric exceeding a threshold; (b) a completeness metric satisfying a required coverage level; and (c) an uncertainty metric falling below a threshold; and
compiling the completed subtask results into a unified response for delivery to the user device.

11. A computer-implemented method for extracting metadata from multimedia content, the method comprising:
receiving, at one or more processors of a metadata extraction engine, multimedia input comprising at least one of video data, audio data, still image data, or textual data captured via one or more hardware sensors of a user device;
performing, by one or more processors, edge processing on the multimedia input to generate key input, wherein the edge processing comprises at least two of:
evaluating a quality score for frames or audio segments and discarding those falling below a fidelity threshold; applying a cropping algorithm to isolate a region of interest within remaining frames; detecting scene transitions; executing an object detection model to identify objects within frames; and selecting representative key frames based on object detection confidence scores;
extracting, by the metadata extraction engine executing on the one or more processors, features from the key input using a hybrid feature-extraction process comprising concurrently executing (i) a large language model (LLM) analysis that generates a natural-language scene description and (ii) a machine-learning-based object detection process that generates bounding-box detections and semantic labels, on a common set of key input;
decomposing, by an orchestration module of the metadata extraction engine, a user request into a plurality of subtasks based on the extracted features and user-specific settings stored in a memory device;
dynamically instantiating, by the orchestration module, a plurality of research agents in memory of a computing system, wherein each research agent is assigned a subtask-specific objective corresponding to one of the plurality of subtasks;
executing the plurality of research agents in parallel on the one or more processors, wherein each research agent queries at least one external data source comprising a search engine, an application programming interface, or a database, to retrieve data relevant to its subtask-specific objective;
compiling, by the metadata extraction engine, outputs from the plurality of research agents into structured metadata stored in memory; and
transmitting the structured metadata from the metadata extraction engine to the user device via a network interface for display on an output device of the user device.

12. The method of claim 11, wherein performing the edge processing further comprises:
executing a fidelity qualification process that applies a trained machine learning model to each frame and audio segment of the multimedia input to compute a numeric quality score, and storing in a buffer only those frames and audio segments having a quality score at or above a predefined fidelity threshold;
applying, to the buffered frames, a region-of-interest cropping algorithm that computes bounding coordinates based on detected scene content to remove background areas, thereby reducing the pixel data transmitted to the metadata extraction engine;
detecting scene changes in the buffered frames by identifying frame-to-frame pixel variance exceeding a scene-change threshold, and segmenting the buffered frames into discrete content segments at detected scene-change boundaries; and
selecting, from each content segment, one or more key frames having the highest object detection confidence scores as the key input for transmission to the metadata extraction engine, thereby reducing the volume of data processed server-side.

13. The method of claim 11, wherein extracting features from the key input further comprises:
executing a first feature-extraction process comprising applying a large language model to the key input to generate a natural-language scene description that identifies objects, people, actions, and contextual relationships present in the key input;
concurrently executing a second feature-extraction process comprising one or more computer-vision machine-learning models, including at least one of a class object detection model or a bootstrapped language-image pretraining (BLIP) model, that generate bounding-box detections and associated semantic labels for objects, people, and places within the key input;
applying, for at least one vertical domain specified in the user settings, one or more domain-specific integrated feature-extraction modules to generate domain-specific feature data supplementing the semantic labels produced by the second feature-extraction process; and
executing a cross-validation process, implemented via a second large language model call, that receives as input both the natural-language scene description and the bounding-box detections and domain-specific feature data, computes a semantic consistency score between the two sets of outputs, identifies and resolves conflicts using contextual reasoning, and stores a single reconciled feature data set, with low-confidence features flagged in a machine-readable structured record, in memory for use by the orchestration module.

14. The method of claim 11, wherein dynamically instantiating the plurality of research agents comprises:
determining, by the orchestration module for each subtask, a modality type by classifying the subtask as pertaining to visual data, audio data, textual data, or a cross-modal combination thereof;
instantiating a Vision Agent in memory and configuring the Vision Agent to execute at least one of object detection, scene segmentation, facial expression analysis, motion tracking, or optical character recognition on visual data, when the subtask modality type is visual;
instantiating an Audio Agent in memory and configuring the Audio Agent to perform at least one of speech recognition, speaker identification, emotion and tone detection, environmental sound classification, or music analysis on audio data, when the subtask modality type is audio;
instantiating a Text Agent in memory and configuring the Text Agent to perform at least one of intent extraction, entity linking, temporal reasoning, or narrative reconstruction on textual data, when the subtask modality type is textual; and
instantiating a Cross-Modal Fusion Agent in memory and configuring the Cross-Modal Fusion Agent to correlate visual events with audio timestamps, speech references with visual objects in co-occurring frames, and emotional tone with facial expression data, to produce a unified cross-modal representation, when the subtask modality type is a cross-modal combination.

15. The method of claim 11, further comprising:
evaluating, by each research agent executing on the one or more processors, an intermediate result generated by that research agent against at least one evaluation criterion comprising: (i) a confidence score computed as a function of cross-source agreement between results returned by at least two distinct tool invocations; (ii) a completeness metric computed as the ratio of subtask-objective information fields populated to the total number of such fields; or (iii) an uncertainty metric derived from variance across multiple language model sampling runs or tool call outputs;
upon determining, by comparing each evaluation criterion to a predefined threshold stored in memory, that a sufficiency condition is not satisfied, dynamically generating in memory at least one independent sub-agent having a narrower subtask objective algorithmically derived from the research agent's subtask objective by identifying the specific information fields that caused the sufficiency condition to fail; and
iteratively refining, by the research agent, the intermediate result based on output received from the sub-agent, by applying a search query expansion procedure that performs at least one of keyword extraction, topic-drift detection, or relevance scoring on the prior intermediate result to formulate a refined query differing from all prior queries issued by the research agent or its sub-agents, until the sufficiency condition is satisfied or a maximum iteration count stored in memory is reached.

16. The method of claim 15, wherein dynamically generating the sub-agent further comprises:
allocating, by the orchestration module at the time of sub-agent instantiation, a computational budget for the sub-agent stored in memory, wherein the computational budget comprises at least one of: (i) a token limit specifying a maximum number of language model inference tokens the sub-agent may consume; (ii) an execution time limit specifying a wall-clock deadline after which the sub-agent is automatically terminated; or (iii) a tool-usage limit specifying a maximum number of aggregated tool invocations across language model queries, web searches, API calls, and database lookups;
encoding the computational budget into the sub-agent's runtime configuration at instantiation such that the sub-agent's execution environment enforces the budget limits as hard constraints; and
automatically terminating the sub-agent upon the earlier of: (i) the sub-agent transmitting a completion signal indicating its narrower subtask objective has been satisfied; or (ii) exhaustion of any one of the allocated budget limits, wherein upon budget-limit exhaustion the sub-agent transmits to the research agent any partial output produced together with a machine-readable indicator identifying which budget limit was exhausted.

17. The method of claim 11, further comprising:
prior to decomposing the user request, retrieving from a memory device: (i) user metadata comprising user-specified preferences and domain interests supplied during a prior configuration session; and (ii) user memory records comprising synthesized records of prior interaction sessions stored by a memory-synthesis process in a user-specific database;
incorporating the retrieved user metadata and user memory records into a research prompt inference process that generates a ranked list of topics of interest, wherein higher-ranked topics receive a greater share of research agent resources during parallel execution; and
after transmitting the structured metadata to the user device, executing a memory-synthesis process that generates a memory object encoding queries made, outputs selected by the user, and inferred preferences from the session, and writing the memory object to the user-specific database in the memory device for retrieval during future sessions.

18. The method of claim 11, wherein executing the plurality of research agents in parallel further comprises:
scheduling the research agents using at least one of a load-balancing algorithm, a priority-based scheduling algorithm, or a dependency-aware scheduling algorithm, wherein a research agent is designated as dependent if its subtask objective requires output produced by another research agent, and dependent research agents are instantiated only after receiving intermediate results from the research agents on which they depend;
selecting, by each research agent in accordance with a tool-selection policy, at least one tool from a set of tools comprising a large language model query, a web search, an application programming interface call, or a database lookup, wherein the tool-selection policy applies at least one of relevance scoring, historical tool performance data, latency constraints, or cost constraints stored in memory to rank available tools; and
routing intermediate results from each research agent to the orchestration module for caching in a shared memory store, such that intermediate results generated by one research agent are retrievable by other concurrently executing research agents to eliminate redundant tool invocations across the parallel agents.

19. The method of claim 11, further comprising:
upon determining that an output of a feature-extraction process or a research agent fails to satisfy a predefined confidence threshold, instantiating in memory an ensemble reasoning cluster comprising a plurality of sub-agents executing concurrently on the one or more processors, wherein each sub-agent of the ensemble receives the same input but operates under a distinct prompt configuration or language model configuration;
aggregating outputs of the concurrently executing sub-agents of the ensemble using a heuristic combining procedure to produce a single aggregated output, wherein the heuristic combining procedure applies at least one of majority voting, confidence-weighted averaging, or cross-output consistency scoring to reduce output variance and hallucination probability; and
substituting the aggregated output for the feature-extraction process output or research agent output in subsequent processing stages of the metadata extraction engine.
